(19) United States
(12) Patent Application Publication
(10) Pub. No.: US 2026/0369148 A1
(43) Pub. Date: Nov. 19, 2026

(54) MONITORING SYSTEM

(71) Applicant: Antares Defence Systems Ltd, Ross-on-Wye (GB)

(72) Inventors: Bruce Terence FULLERTON, Ross-on-Wye (GB); Paul Brian DEACON, Ross-on-Wye (GB)

(73) Assignee: Antares Defence Systems Ltd, Ross-on-Wye, HE (GB)

(21) Appl. No.: 19/148,418

(22) PCT Filed: Feb. 9, 2023
(86) PCT No.: PCT/EP2023/053252

§ 371 Date: Jul. 16, 2025

(30) Foreign Application Priority Data
Jan. 17, 2023 (GB) 2300678.6

(51) Int. Cl. G08B 21/02; G08B 25/00; G08B 25/10; H04N 7/18

(52) U.S. Cl. CPC G08B 21/02; G08B 25/007; G08B 25/10; H04N 7/183

(57) ABSTRACT

The present invention relates to a monitoring system comprising a monitoring device and a base station. The monitoring device comprises a transceiver for detecting and identifying user equipment proximal to the wearable device to provide user equipment identification data, and a transmitter. The monitoring device further comprises a processor configured to receive the user equipment identification data, encrypt the user equipment identification data using an encryption algorithm, and transmit the encrypted data using the transmitter. The base station comprises a receiver for receiving the encrypted data transmitted by the transmitter of the monitoring device; a base processor configured to decrypt the encrypted data using the encryption algorithm, a secure data storage medium configured to receive and store the decrypted data from the base processor.

### FIELD OF INVENTION

The present invention relates to monitoring systems, particularly monitoring systems for gathering and storing live data for the purpose of post-event analysis, for example, for analysing data collected during crowd, checkpoint, or border control missions.

### BACKGROUND TO THE INVENTION

Effective control of people at a location should prevent incidents such as crushes, fights, riots, or other disorderly behaviour, therefore helping to ensure the safety of all people present at the location. However, sometimes disorderly behaviour can still occur, particularly when there is a large number of people congregating at the location (such as at a protest) and/or alcohol is being consumed irresponsibly (such as at an outdoor festival) and/or there are individuals present with malicious intent (such as terrorists).

Typical tactics for controlling people, particularly large groups of people (crowds), include managing traffic flows (e.g., one-way systems for vehicles and pedestrians), barriers/barricades, clearly signposted rules and consequences of not following them (e.g., prohibited items will be confiscated), clearly marked directions (particularly to the emergency exits, or checkpoint stops), and controlling/limiting the sale of alcohol. It is also necessary to have sufficient security personnel and/or police officers and/or other law enforcement personnel on site to deal with problem individuals or groups, as well as to monitor the behaviour of the crowd and particular individuals and sub-groups within the crowd, and then communicate relevant information to the appropriate people.

Authorised individuals can use a camera to record the crowd or a particular group or individual of interest, which can help to identify and track individuals within a surveilled area. There are various standards however which the recording must satisfy to be used as evidence in legal proceedings. In particular, the recording must have a verifiable and documented chain of custody, and the video must be authenticated and verified. However, even if the footage can be authenticated and verified, if it is not of high enough quality (for example, too low resolution, or grainy, or blurry), or the individual's face is partially obscured, then the defence could argue that the footage does not prove to the appropriate legal standard that the defendant was present at the location at the time in question.

The present invention aims to overcome some shortcomings of the prior art by providing an improved monitoring system having an output which is less likely to be challenged in court proceedings.

### SUMMARY OF THE INVENTION

In accordance with a first aspect of the invention, there is provided a monitoring system comprising:
a monitoring device, the monitoring device comprising:
   a transceiver for detecting and identifying user equipment proximal to the monitoring device to provide user equipment identification data;
   a transmitter; and,
   a processor configured to:
      receive the user equipment identification data,
      encrypt the user equipment identification data using an encryption algorithm;
      transmit the encrypted data using the transmitter; and;
wherein the system further comprises a base station, the base station comprising:
   a receiver for receiving the encrypted data transmitted by the transmitter of the monitoring device;
   a base processor configured to decrypt the encrypted data using the encryption algorithm; and,
   a secure data storage medium configured to receive and store the decrypted data from the base processor.

The monitoring device can further comprise a camera for capturing a video stream. The camera may have a fixed viewing angle. Alternatively, the camera may be a remote control camera, such that the camera angle can be adjusted remotely. For example, the camera can be controlled remotely from the base station, such as by an operator. The monitoring device transmitter may be a transceiver. The base station receiver may be a transceiver. The monitoring device and base station transceivers may be configured to communicate verbal or audible commands. For example, an operator in the base station can instruct a wearer of the monitoring device to maintain or change position, and in reply, the wearer can acknowledge receipt of the instructions.

The monitoring device can be portable, such as wearable. The camera can be configured to attach to the chest area, the shoulder area, and/or on the head area of a wearer. The camera can be a forward-facing camera, and, when mounted will face in the direction the wearer is standing and/or in the direction that the wearer is looking. Alternatively, the monitoring device may be located within a manned or unmanned vehicle, such as a road vehicle or a drone. Alternatively, or additionally, the monitoring device can be immobile, such as at a fixed location, for example, at a checkpoint. The camera can be mounted to a fixed location, particularly a location having an appropriate vantage point, such as at the top of a pole or tower, or a building rooftop or wall.

The monitoring device can additionally comprise one or more sensors to capture live environmental and situational data, and biometric data of a user. The one or more sensors can include, but are not limited to: a video sensor to interpret images in the video stream; audio sensors to detect sound waves (such as a microphone); a dosimeter to detect and measure radiation exposure; a CDRM sensor (cardiac device remote monitoring sensor) to monitor cardiovascular health; and a body temperature sensor.

Preferably, the monitoring device comprises one or more audio sensors, such as microphones, to capture audio data. The one or more audio sensors may be located within the camera. The camera may be configured to capture an audio-visual stream.

The user equipment can be any mobile device capable of connecting to a wireless network, such as a cellular, Wi-Fi, or Bluetooth network, including smartphones, tablets, laptop computers, and smartwatches. The transceiver can comprise one or more of: an IMSI-monitor, a Wi-Fi monitor, and a Bluetooth monitor. The user equipment identification data can comprise one or more of: an International Mobile Equipment Identity (IMEI) number (a unique code given to a mobile device), an International Mobile Subscriber Identity (IMSI) number (a unique identifier given to a user of a cellular network), a Media Access Control (MAC) address (a unique code that identifies a device on a Wi-Fi network), a Bluetooth Device Address (BD_ADDR; a unique identifier assigned to a Bluetooth device), Basic Service Set Identifier (BSSID; a unique identifier of a Wi-Fi router or access point), Extended Service Set Identification (ESSID; a unique name of a Wi-Fi network), universally unique identifier (UUID; a unique identifier assigned to a particular service provided by a Bluetooth device), and the Bluetooth device's Name/Type.

The IMSI monitor may have a range of up to several kilometers (km), such as up to 1 km, optionally up to 5 km, or optionally up to 10 km. The Wi-Fi monitor may have a range of up to several hundreds of meters (m), such as up to 100 m, optionally up to 500 m, or optionally up to 1000 m. The Bluetooth monitor may have a range of up to tens of meters (m), such as up to 10 m, optionally up to 50 m, or optionally up to 100 m. The definition of the term “proximal” will therefore depend on whether the transceiver comprises an IMSI monitor, a Wi-Fi monitor, and/or a Bluetooth monitor. The transceiver may preferably be a passive device, and so the range may be in part determined by the size of the antenna and receiver amplifier included within the transceiver.

The processor of the monitoring device can be configured to simultaneously receive data inputs from the transceiver, the camera, and/or the one or more sensors. The processor of the monitoring device can be configured to additionally encrypt and transmit the video stream from the camera and the sensor data from the one or more sensors. The encrypted user equipment identification data and/or the video stream and/or the sensor data can be separately transmitted to the base station. The base processor can be additionally configured to decrypt the encrypted video stream and sensor data using the encryption algorithm.

The processor of the monitoring device can be configured to embed a timestamp within the user equipment identification data and/or the video stream and/or the sensor data, such as the time and/or the date (the number of the day, month, and year). The processor of the monitoring device can be configured to embed location data associated with the monitoring device within the user equipment identification data and/or video stream and/or sensor data, such as latitude and longitude coordinates.

The timestamp and/or location data can be embedded within the video stream and/or the user equipment identification data and/or the sensor data prior to encrypting and transmitting the data to the base station. The base processor can subsequently run the decrypted data through a detection algorithm to extract the embedded timestamp and/or location data if needed.

In embodiments, the video stream can be continuously transmitted to the base station. The sensor data can also be continuously transmitted to the base station. There may be a delay, or lag, of up to 1 second between transmitting the encrypted video stream and/or sensor data and receiving the data at the base station. The decrypted video stream and/or sensor data can be displayable on a screen for near real-time viewing. There may be a delay of up to 1 second between transmitting the encrypted data and viewing the decrypted video stream and/or sensor data on the display.

The transceiver can continuously scan a range or spectrum of frequencies or bandwidths, and any user equipment identification data detected and identified can be transmitted intermittently to the base station. For example, all user equipment identification data gathered within a predefined period of time may be grouped into a single data packet, and the data packet is transmitted to the base station. The predefined period of time may be configurable, and may be up to 30 seconds, optionally up to 20 seconds, or optionally up to 10 seconds. As such, the user equipment identification data can be transmitted to the base station as a packet or bundle of data at configurable intervals of time, for example up to 30 seconds, optionally up to 20 seconds, or optionally up to 10 seconds. Alternatively, the period of time may be dynamically configurable, such that the data packet can be transmitted to the base station once it reaches a predefined size. As such, the period of time between transmissions may vary depending on how long it takes for the data packet to reach the predefined size. A timestamp and/or the location data of the monitoring device can be embedded in the data packet prior to being encrypted and then transmitted to the base station. The decrypted user equipment identification data can be displayable on a screen in the base station for intermittent viewing. That is, the data displayed may be refreshed at an interval equal to the predefined period of time.

In some embodiments, a portion of the user equipment identification data and a portion of at least one of: the video stream and the sensor data, each having the same timestamp or range of timestamps, and the same location information, can be combined by the processor to create a fused data packet spanning a predefined period of time, such as 10 seconds. The fused data packet can be encrypted and transmitted intermittently to the base station. The period of transmission can be limited by the predefined period of time for the data packet. The data contained within the decrypted fused data packet can be displayable on a screen in the base station for intermittent viewing. That is, the data displayed may be refreshed at an interval equal to the predefined period of time.

The transmitter may provide a single encrypted radio link to the base station. The radio link can be constantly open and available for data to be transmitted to the base station.

The monitoring system can comprise a plurality of monitoring devices. The monitoring system can comprise a plurality of base stations. The transmitter of the at least one monitoring device can be a transceiver. The base station receiver can be a transceiver. Each monitoring device can communicate via an encrypted mesh network. The mesh network may be a radio mesh network. The mesh network can communicate with a base device located in the or each base station, such as the or each receiver or transceiver. The or each base device can be a high-power base radio device. The mesh network can provide multiple encrypted radio links from each monitoring device to one or more base stations. That is, there may be multiple routes through the mesh network for transmitting the data to a base station. The monitoring system may be configured to transmit the data along the most appropriate route through the mesh network, for example, the route which will transmit the data the fastest from the monitoring device to a base station. Each encrypted radio link can be constantly open and available for data to be transmitted through the mesh network.

The user equipment identification data, video stream, and sensor data, can each be independently transmitted to the base station via the single radio link or via the mesh network. Alternatively, fused data packets can be transmitted to the base station via the single radio link or via the mesh network.

The base station can be a portable device. The base station can be located within a mobile unit, such as a vehicle. Alternatively, or additionally, the base station can be immobile, such as at a fixed location, for example, at a checkpoint.

The secure data storage medium may comprise one or more of: an external hard drive, a memory card, a flash drive, a solid-state drive (SSD), a computer hard disk drive, network storage, and cloud storage. It will be understood that other suitable forms of non-volatile memory and storage media can be used. The secure data storage medium can be configured to additionally receive and store the decrypted video stream and sensor data.

In accordance with a second aspect of the invention, there is provided a monitoring system comprising:
a monitoring device, the monitoring device comprising:
   a camera for capturing a video stream;
   a transceiver for detecting and identifying user equipment proximal to the monitoring device to provide user equipment identification data;
   a transmitter; and,
   a processor configured to:
      receive input data from the camera and transceiver,
      encrypt the input data from the camera and transceiver using an encryption algorithm, and
      transmit the encrypted data using the transmitter;
and wherein the system further comprises
   a base station, the base station comprising:
      a receiver for receiving the encrypted data transmitted by the transmitter of the at least one monitoring device; and,
      a base processor configured to decrypt the encrypted data using the encryption algorithm; and,
      a secure data storage medium configured to receive and store the decrypted data from the processor.

Whilst the invention has been described above, it extends to any inventive combination set out above, or in the following description or drawings.

### BRIEF DESCRIPTION OF THE DRAWINGS

Specific embodiments of the invention will now be described in detail by way of example only and with reference to the following drawings, in which:

FIGS. 1a and 1b show a wearable device in accordance with embodiments of the present invention;

FIGS. 2a and 2b show a base station in accordance with embodiments of the present invention; and,

FIGS. 3a and 3b schematically show the processes for capturing, processing, and transmitting data in accordance with the present invention.

### DETAILED DESCRIPTION OF EMBODIMENTS

Embodiments described herein provide an improved system for crowd control, for example at events such as concerts, festivals, protests, sporting events, and gatherings for public figures such as prominent politicians and royalty, checkpoints, and border control.

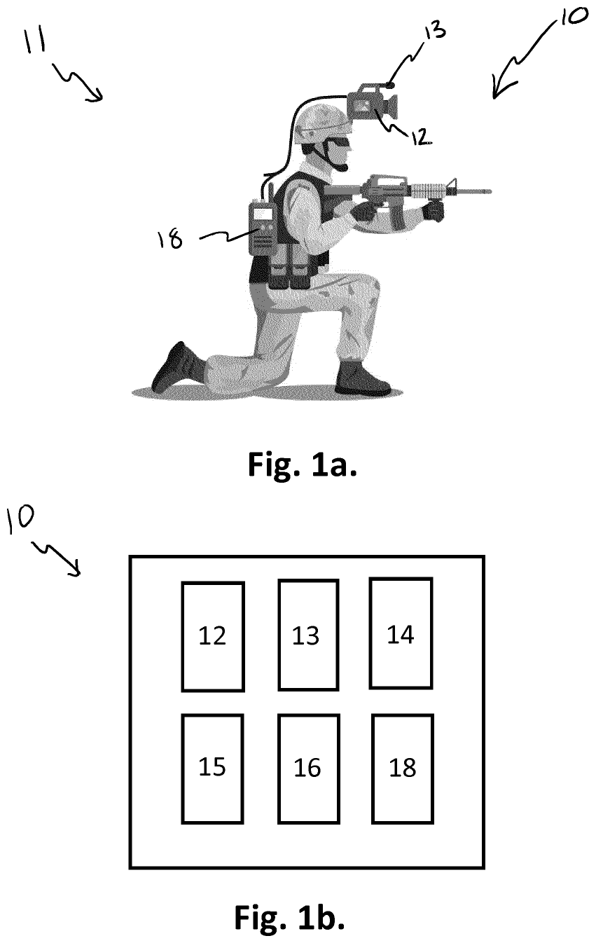

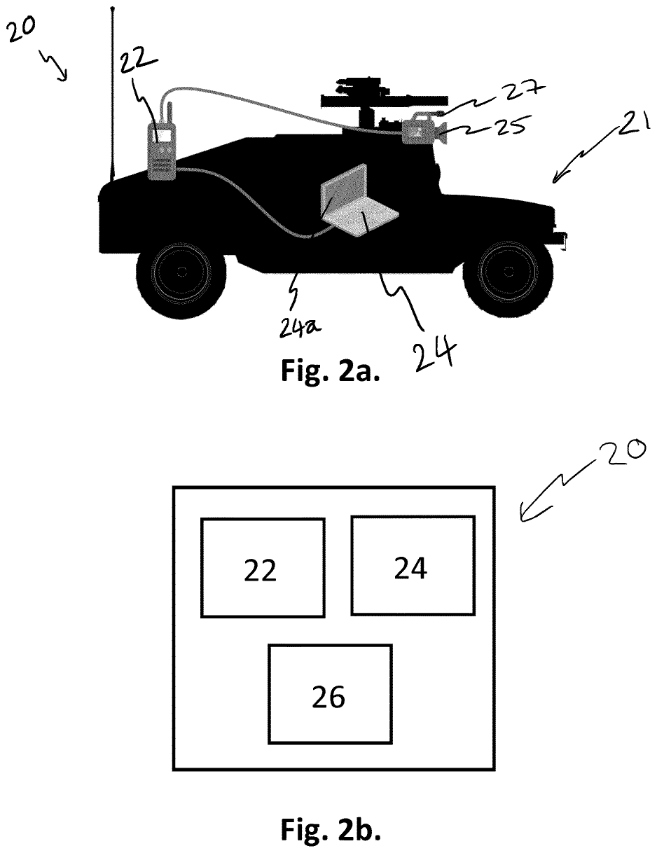

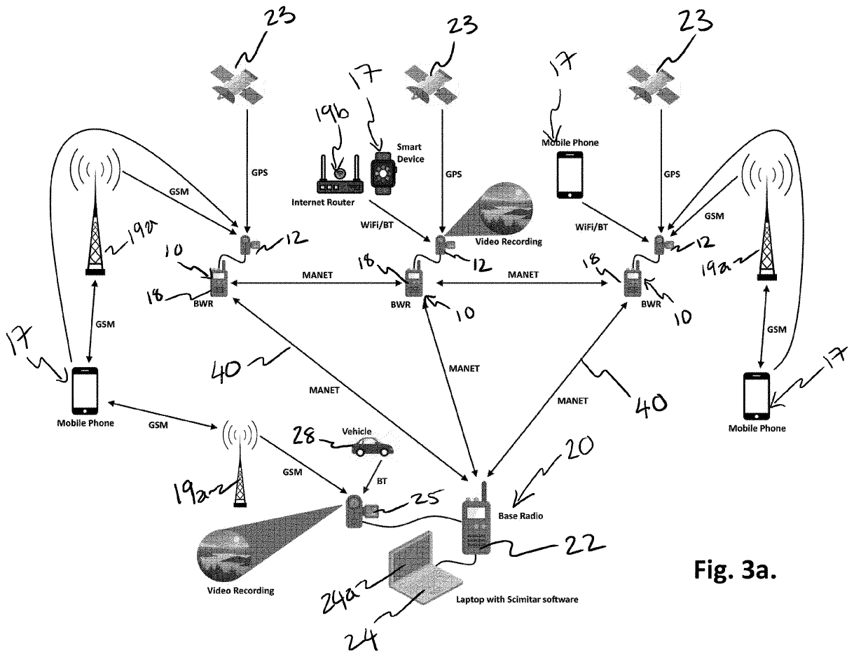

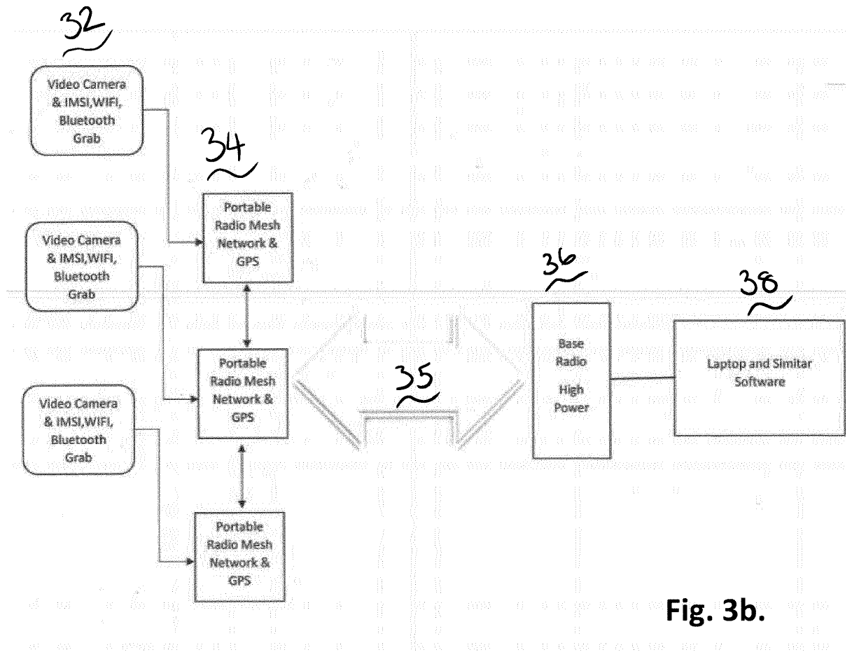

FIGS. 1a, 1b, 2a and 2b show the various components of the monitoring system according to the present invention, including a person 11 wearing a monitoring device 10 (as shown in FIGS. 1a and 1b) and a mobile vehicle 21 comprising a base station 20 (as shown in FIGS. 2a and 2b). There will typically be several individual people 11 (such as law enforcement) each wearing a monitoring device 10, preferably spaced apart throughout the area/location to be monitored (as shown in FIG. 3a). This can allow different perspectives/viewpoints of the area/location, different viewpoints of a particular incident, and can also help to track individuals through the area/location.

There may also be several base stations 20, with each base station located within a different mobile vehicle 21. Each mobile vehicle 21 is preferably spaced apart, such as around the perimeter of the area/location. FIG. 2a also shows a further monitoring device located within the mobile vehicle 21, which will be described in further detail below. In some embodiments, the monitoring device 10 can be immobile, that is not portable, and can have a fixed geographical location. Likewise, the base station 20 can have a fixed geographical location.

The monitoring device 10 comprises a camera 12 and a microphone 13 for capturing video and audio footage (audio-visual footage), in particular, footage of a crowd or individuals or groups of individuals within the crowd. The camera 12 is placed on a helmet worn by the person 11, which is at a location suitable for capturing individuals within the crowd, in particular their facial features. The camera 12 is typically a forward-facing camera, and, when mounted on the helmet, will face in the direction that the person 11 is looking so that the camera 12 captures what the person 11 is seeing. In embodiments, the camera 12 can be controlled remotely by an observer located in the mobile vehicle 21. This can enable the observer to adjust the viewing angle of the camera to get a better view of a person, group, or incident of interest.

The wearable monitoring device 10 also comprises a processor 16 and a transmitter 18. The camera 12 and microphone 13 continuously capture video and audio data, which is received by the processor 16, and then continuously transmitted via the transmitter 18 to the base station 20. The audio-visual footage can then be viewed in near real-time, with an expected lag of up to 1 second, at the base station 20.

The wearable monitoring device 10 also comprises sensors 15 to capture live environmental and situational data, and biometric data of the wearer, such as heart rate and body temperature. The data collected by the sensors 15 is received by the processor 16, and then continuously transmitted via the transmitter 18 to the base station 20. The sensor data can then be viewed in near real-time, with an expected lag of up to 1 second, at the base station 20.

The wearable monitoring device 10 also comprises a transceiver 14 for detecting and identifying user equipment proximal to the wearable device 10 to provide user equipment identification data. As shown in FIG. 3a, the user equipment can be a mobile device 17 capable of connecting to a wireless network and having a MAC address, such as a mobile phone, smartwatch, or tablet. It is estimated that over 80% of the UK population own a mobile phone (with similar statistics on a global scale), therefore it is reasonable to assume that the majority of devices identified within a defined location will be mobile phones. Security personnel and/or police officers and/or other law enforcement can identify and track individuals in a surveilled area by capturing the user equipment identification data associated with their mobile device 17. For example, they can use an IMSI-monitor to locate and track mobile phones that are connected to a wireless network.

It will be appreciated that the transceiver 14 is only listening to the signals sent between a cell tower 19a and a mobile device 17 via the Global System for Mobile Communication (GSM), and/or a mobile device 17 and an internet router 19b communicating via Wi-Fi signals, and/or a mobile device 17 communicating with other nearby devices via Bluetooth. The transceiver 14 does not communicate with any mobile devices 17 directly, and so they are unaware of the transceiver's presence. That is, the transceiver 14 is undetectable. The transceiver 14 is therefore non-invasive (or passive), and cannot access any content stored on any mobile device 17. The transceiver 14 only identifies and communicates the detected user equipment identification data to the processor 16 for processing and transmitting to a base station 20.

When a mobile device 17 is powered on it connects to a cell tower 19a via GSM, which is usually the closest cell tower or the cell tower with the strongest signal strength. The IMSI data is used to authenticate the SIM card and identify the user to the mobile network, and also provide information on the location of the device 17. The mobile device 17 performs periodic location updates, particularly when it moves to a new area and connects to a different cell tower 19a which is closer or has a stronger signal strength compared to the initial cell tower 19a, and as such the location of a mobile device 17 can be tracked.

The user equipment identification data gathered, which may also be referred to as telemetry data, cannot unequivocally prove that a particular individual was at a particular location at a particular time. The present invention recognises that audio-visual footage taken alone, and user equipment identification data taken alone, can often be challenged in court, and have doubt cast upon what the footage or data proves.

The transceiver 14 comprises at least an IMSI-monitor, and the user equipment identification data comprises the IMSI number of the mobile device 17. Given that the transceiver 14 is a passive device, the range of the IMSI-monitor will depend on size and power of the cell tower 19a it is connected to, and also the size of the antenna and receiver amplifier included within the transceiver 14. More powerful cell towers and/or larger receivers will be able to detect the IMSI data (or other appropriate telemetry data) for mobile devices located further away from the transceiver 14.

In use, the transceiver 14 continuously scans a spectrum of bandwidths. When a mobile device 17 or a cell tower 19a communicating with the mobile device 17 is within the range of the transceiver 14, the transceiver 14 can identify the mobile device 17 by the appropriate telemetry data, such as its unique MAC address. The transceiver 14 can then identify the IMSI data, and send it (along with any other identified telemetry data) to the processor 16. The transmitter 18 does not transmit the telemetry data continuously. The processor 16 will combine the telemetry data for each mobile device 17 identified within a predefined period of time, such as 10 seconds, into a single data packet. This single data packet will then be transmitted via the transmitter 18 to the base station 20. As such, there can be a delay of up to 10 seconds between gathering the telemetry data, and receiving it at the base station 20. The predefined period of time may be shorter or longer depending on the specific requirements of the mission.

The processor 16 can receive the audio-visual data, the telemetry data, and the sensor data, simultaneously.

Before the data or data packets are transmitted to the base station 20, the processor 16 separately embeds a timestamp, and the location data of the monitoring device, within the telemetry data associated with each mobile device identified, the audio-visual data, and the sensor data. The embedded data may be referred to as a watermark. The timestamp and/or location data may be embedded in the data signal itself or within the metadata.

The timestamp and/or the location data can be obtained using satellite navigation systems 23, such as GPS (the Global Positioning System). Alternatively, the timestamp can be based on International Atomic Time (TAI) or Coordinated Universal Time (UTC). GPS, TAI and UTC time are related but offset from one another by known amounts. Timestamps derived from GPS, TAI or UTC can help to authenticate the data and ensure evidential integrity if the data is presented as evidence in legal proceedings.

It is important for evidential purposes that the time and date are regularly updated/calibrated to ensure accuracy where necessary, otherwise, it may not be possible to authenticate the audio-visual footage, which can prevent it from being used as evidence in court.

The processor 16 also separately applies a check value to each of the user equipment identification data (telemetry data), the audio-visual data, and the sensor data, prior to encrypting and transmitting the data. Typically, the check value is based on the remainder of a polynomial division of the data contents to be transmitted. In use, the base processor 24 (shown in FIGS. 2a and 2b) receives the encrypted data, runs it through a decryption algorithm, and then runs a cyclic redundancy check (CRC), which can involve repeating the same polynomial calculations and comparing the resulting check value. If the check values do not match, this can indicate that the data has been corrupted during transmission, and contains an error. Appropriate corrective action can then be taken to correct the error where possible. Otherwise, if the check values match, the data can be assumed to be error-free. A CRC can therefore help to detect communication errors, and also help to verify the integrity of the data.

The processor 16 also separately applies a digital signature to each of the user equipment identification data (telemetry data), the audio-visual data, and the sensor data. The digital signature is typically generated using asymmetric cryptography, and can be used to authenticate the origin of the data (i.e., that it was sent directly from the monitoring device 10). The data is signed using a private key prior to transmission. Once the data is received at the base station 20, the signature can be verified using a known public key. If verification is successful, it can be assumed that the data has come directly from the monitoring device 10. However, if the public key fails to verify the data, it can be assumed that the data was not sent directly from the monitoring device 10 or that it was intercepted prior to being received at the base station 20. Data received at the base station 20 with a digital signature that cannot be verified may be flagged and dismissed as lacking authenticity, and as such it will be inadmissible as evidence in legal proceedings.

After the timestamp, location data, and check value have been applied to each of the user equipment identification data (telemetry data), the audio-visual data, and the sensor data, the resulting data signals are encrypted. Typically, the digital signature is applied after the data is encrypted. The processor 16 encrypts each data signal using a key-based encoding/encrypting algorithm. It is necessary to encrypt the data before transmission to help prevent third parties from intercepting the data or data packets and tampering with them. This can help to maintain the chain of custody of the data and ensure that it can be verified if needed as evidence in court.

Sections of each data input having the same timestamp or range of timestamps, and the same location information, can be combined to create a fused data packet. For example, if the telemetry data, video stream and sensor data are all captured across the same period of time and at the same location, they may be fused together to create a more complete representation of an event occurring within that time period. The time period may be up 10 seconds long, thus the fused data packet may be up to 10 seconds in length. The fused data packet can be encrypted and transmitted to the base station, optionally including a check value and digital signature as described above. The fused data packets are transmitted to the base station 20 intermittently, such as every 10 seconds.

The transmitter 18 can transmit the encrypted data or fused data packets separately to the base station 20.

As shown in FIG. 2a, the base station 20 additionally comprises a monitoring device, having a camera 25 and a microphone 27. As shown in FIG. 3a, the base station monitoring device can comprise a transceiver which can scan for Bluetooth signals, particularly from surrounding vehicles 28 (in which Bluetooth functionality is enabled). The base station monitoring device functions in the same way as the monitoring device 10 described above. However, in some embodiments (as shown in FIGS. 2a and 3a), the audio-visual and user equipment identification data are transmitted to the base station transceiver 22 via a wired connection, rather than a wireless connection through a mesh network. The data collected by the monitoring device 10, and by the base station monitoring device, are together transmitted to the processor 24 for processing, as described herein. Each transmitter 18 of each wearable monitoring device 10 is part of a wireless radio mesh network. Each transmitter 18 forms one node in the network, and acts as a router for every other node. As such, each transmitter 18 in the wearable monitoring device 10 can also have receiver capabilities and may therefore be a transceiver. A main node, or transceiver 22 (located within the base station 20), acts as the gateway node, and all data is forwarded to and from the gateway node via the other “router” nodes.

The transceiver 22 (shown in FIG. 2b) can be a high-powered base radio station. Each transmitter 18 of each wearable monitoring device 10 individually boosts the radio signal, and also determines the best route to take through the network to transmit the data quickly and efficiently from a particular transmitter 18 to the nearest base station 20.

The mesh network 40 allows data to be transmitted over a larger and more dynamic area compared to having a single router. The size of the network can easily be amended, and nodes can be added or taken away without affecting the rest of the network. Therefore, if a single transmitter 18 is damaged or taken out of action, the rest of the network adjusts, and the data is rerouted accordingly.

The mesh network 40 provides a radio link to the base station which is constantly open and available for data to be transmitted, either continuously or intermittently as described above.

As shown in FIG. 2b, the base station 20 comprises a transceiver 22, as discussed above, for receiving the encrypted data transmitted from each wearable monitoring device 10. The base station 20 also comprises a processor 24 which runs the encrypted data through a decryption algorithm (which is the same as the encryption algorithm but in reverse). The decryption algorithm requires the encryption key to decrypt the data. The encryption/decryption process, therefore, uses a pre-shared key (PSK) which is securely shared between the transmitter 18 and transceiver 22 prior to any data transmission.

The decrypted data can also be run through a detection algorithm to extract the embedded timestamp and/or location data, if required.

The decrypted audio-visual data and the sensor data can be displayed on one or more screens for near real-time viewing at the base station 20 by an operator. The operator can be immediately alerted to any problems, such as issues with the health of the wearer of the device 10 (particularly as an incident unfolds), and assistance/instructions can be provided accordingly.

The operator can also communicate with each wearer 11 via transceiver 22, the mesh network, and transceiver 18, and can instruct/advise them on a situation. For example, the operator may provide instructions to follow a suspicious individual, or to ask for information, such as to obtain the wearer's verbal feedback on the general atmosphere at the location, or a verbal status update on the wearer's wellbeing as an incident unfolds. The operator may provide verbal or audible commands instructing the wearer 11 to maintain or change position, as well as remotely directing the camera 12, if required.

The decrypted audio-visual data, sensor data, and user equipment identification data (telemetry data) are also stored on a secure data storage medium 26 for reviewing at a later time (such as during post-mission analysis/debriefing). The secure data storage medium may comprise one or more of: an external hard drive, a memory card, a flash drive, a solid-state drive (SSD), a computer hard disk drive, network storage, and cloud storage. It will be understood that other suitable forms of non-volatile memory and storage media can be used.

The transceiver 22, processor 24, storage medium 26, and display screen 24a, can be part of a single computing device, such as a laptop located within the or each mobile vehicle 21, or they can be spaced apart (that is, at separate locations). For example, the storage medium 26 may be cloud-based, and therefore located remotely from the mobile vehicle 21.

FIG. 3 shows a flow diagram 30 schematically illustrating the process for capturing, processing, and transmitting the audio-visual footage and user equipment identification data (telemetry data). The process begins at step 32 whereby each wearable monitoring device 10 operates as described above to capture the audio-visual footage via the camera 12 and microphone 13, and the telemetry data via the transceiver 14, which includes at least an IMSI-monitor. This data is collected from each monitoring device 10 at step 32. The audio-visual footage and the telemetry data are then sent to the processor at step 34, along with any sensor data collected, such as the heart rate and body temperature of the wearer. At step 34, each processor embeds a timestamp and the location data of the respective monitoring device 10 into each of the telemetry data, the sensor data, and the audio-visual data.

A check value is then applied to each data signal, before running each data signal through an encryption algorithm. Once encrypted, a digital signature is applied to the data, as described above.

The encrypted data signals are then separately transmitted via transmitter 18 through the radio mesh network 40 at step 35. Each device 10 acts as a node in the mesh network 40, and the data will be transmitted to the nearest base station 20 via the series of nodes deemed to be the quickest and most efficient route. The data is received by a transceiver 22, which is a high-power base radio, at step 36.

At step 38, the encrypted data signals are then decrypted and stored in a secure data storage medium 26. Additionally, the audio-visual and sensor data can be viewed in near real-time (having around 1 second lag). The telemetry data can be viewed intermittently as a data packet, at predefined periods of time, such as every 10 seconds. In the case of fused data packets, the audio-visual, sensor, and telemetry data can each be viewed intermittently at predefined periods of time, such as every 10 seconds.

The decrypted data signals can also be run through a detection algorithm to extract the timestamp and location information if needed.

Whilst the principle of the invention has been illustrated using exemplary embodiments, it will be understood that the invention is not limited to exemplary embodiments and that the invention may be embodied by other variants defined within the scope of the appended claims.

1-25. (canceled)

26. A monitoring system, comprising:
a monitoring device, the monitoring device comprising
a transceiver for detecting and identifying user equipment proximal to the monitoring device to provide user equipment identification data,
a transmitter, and
a device processor configured to
receive the user equipment identification data,
encrypt the user equipment identification data using an encryption algorithm to generate encrypted data, and
transmit the encrypted data using the transmitter; and
a base station, the base station comprising
a receiver for receiving the encrypted data transmitted by the transmitter of the monitoring device,
a base processor configured to decrypt the encrypted data using a decryption algorithm to generate decrypted data, and
a secure data storage medium configured to receive and store the decrypted data.

27. The monitoring system as claimed in claim 26, wherein the monitoring device further comprises a camera for capturing a video stream.

28. The monitoring system as claimed in claim 27, wherein the monitoring device additionally comprises one or more sensors to capture sensor data including live environmental and situational data, and biometric data of a user.

29. The monitoring system as claimed in claim 28, wherein the monitoring device comprises one or more audio sensors to capture audio data.

30. The monitoring system as claimed in claim 28, wherein the device processor is configured to simultaneously receive data inputs from the transceiver, the camera, and the one or more sensors.

31. The monitoring system as claimed in claim 30, wherein the device processor is configured to additionally encrypt and transmit the video stream from the camera and the sensor data from the one or more sensors.

32. The monitoring system as claimed in claim 31, wherein the encrypted data and/or the video stream and/or the sensor data are separately transmitted to the base station.

33. The monitoring system as claimed in claim 28, wherein the device processor is configured to embed a timestamp within the user equipment identification data and/or the video stream and/or the sensor data.

34. The monitoring system as claimed in claim 33, wherein the device processor is configured to embed location data associated with the monitoring device within the user equipment identification data, and/or the video stream, and/or the sensor data.

35. The monitoring system as claimed in claim 34, wherein the base processor runs the decrypted data through a detection algorithm to extract the timestamp and/or the location data.

36. The monitoring system as claimed in claim 34, wherein a portion of the user equipment identification data and a portion of at least one of: the video stream and the sensor data, each having the same timestamp or range of timestamps, and the same location information, are combined by the device processor to create a fused data packet spanning a defined period of time.

37. The monitoring system as claimed in claim 36, wherein the fused data packet is encrypted and transmitted intermittently to the base station.

38. The monitoring system as claimed in claim 27, wherein the video stream is continuously transmitted to the base station.

39. The monitoring system as claimed in claim 28, wherein the sensor data is continuously transmitted to the base station.

40. The monitoring system as claimed in claim 26, wherein the transceiver continuously scans a range or spectrum of frequencies or bandwidths, and any user equipment identification data detected and identified is transmitted intermittently to the base station.

41. The monitoring system as claimed in claim 32,
wherein all user equipment identification data detected and identified within a predefined period of time is grouped into a single data packet, and
wherein the single data packet is transmitted to the base station.

42. The monitoring system as claimed in claim 26, wherein the transceiver comprises one or more of: an IMSI-monitor, a Wi-Fi monitor, and a Bluetooth monitor.

43. The monitoring system as claimed in claim 26, wherein the user equipment identification data comprises one or more of: an International Mobile Equipment Identity (IMEI) number, an International Mobile Subscriber Identity (IMSI) number, a Media Access Control (MAC) address, a Bluetooth Device Address (BD_ADDR), a Basic Service Set Identifier (BSSID), an Extended Service Set Identification (ESSID), a universally unique identifier (UUID), and any associated Bluetooth Name/Type.

44. The monitoring system as claimed in claim 43,
wherein each monitoring device communicates via a mesh network, the mesh network being a radio mesh network, and
wherein a high-power base radio device is located in each base station.

45. A monitoring system, comprising:
a monitoring device, the monitoring device comprising
a camera for capturing a video stream,
a transceiver for detecting and identifying user equipment proximal to the monitoring device to provide user equipment identification data,
a transmitter, and,
a processor configured to
receive input data from the camera and transceiver,
encrypt the input data from the camera and transceiver using an encryption algorithm to generate encrypted data, and
transmit the encrypted data using the transmitter; and
a base station, the base station comprising
a receiver for receiving the encrypted data transmitted by the transmitter of the monitoring device,
a base processor configured to decrypt the encrypted data using a decryption algorithm to generate decrypted data, and
a secure data storage medium configured to receive and store the decrypted data from the processor.
